(19) United States
(12) Patent Application Publication
(10) Pub. No.: US 2024/0176453 A1
(43) Pub. Date: May 30, 2024

(54) APPARATUS FOR PROVIDING METAVERSE SERVICE USING HOLOGRAM AND METHOD FOR CONTROLLING THE SAME

(71) Applicant: MARKETON INC, Seoul (KR)

(72) Inventor: Chang Joon Yang, Seoul (KR)

(73) Assignee: MARKETON INC, Seoul (KR)

(21) Appl. No.: 18/192,072

(22) Filed: Mar. 29, 2023

(30) Foreign Application Priority Data
Nov. 25, 2022 (KR) 10-2022-0160421

(51) Int. Cl. G06F 3/042; G02B 30/56; G06F 3/14

(52) U.S. Cl. CPC G06F 3/042; G02B 30/56; G06F 3/1423; G06F 2203/04108

(57) ABSTRACT

The present disclosure relates to an apparatus for providing a metaverse service using hologram and a method for controlling the same. The apparatus may include a housing; a plurality of displays installed on each side of the housing at a predetermined angle with respect to a vertical direction and displaying an image; a hologram plate disposed on an upper side of the housing in a horizontal direction and projecting an image displayed on each display as a holographic image in air above each of the displays; a non-contact sensor disposed on top of at least one of the plurality of displays to detect a user's non-contact input; and a controller for processing the user's non-contact input detected through the non-contact sensor. The present disclosure allows a more realistic service by providing a metaverse service using hologram and does not require to wear an additional device, thereby reducing users' inconvenience. In addition, as holographic image is provided in a plurality of directions (e.g., in four directions) according to examples of the present disclosure, viewing angle problem may be resolved.

### CROSS-REFERENCE TO RELATED APPLICATION

This application is based on and claims priority under 35 U.S.C. 119 to Korean Patent Application No. 10-2022-0160421, filed on Nov. 25, 2022 in the Korean Intellectual Property Office, the disclosure of which is herein incorporated by reference it its entirety.

### BACKGROUND

### 1. Field

The following description relates to an apparatus for providing a metaverse service using hologram and a method for controlling the same.

### 2. Description of Related Art

Recently, the interest in virtual reality (VR), augmented reality (AR), mixed reality (MR), extended reality (XR), and metaverse is increasing. For example, interest in exhibitions, performances, video conferencing services using a metaverse (hereinafter referred to as metaverse service) is increasing, and related devices are being developed and sold.

However, most of the currently known devices providing a metaverse service are a type of devices worn on a part of a user's body (e.g., head, face) (hereinafter referred to as wearable devices), such as a head mounted device (HMD), smart glasses, and HoloLens™.

Due to this, in order to use the metaverse service, the user has to wear the wearable device every time, which is inconvenient. Additionally, there may be an issue that symptoms of digital sickness (or cybersickness, or three-dimensional (3D) motion sickness) happens when a wearable device is used for a long time.

### SUMMARY

The present description is to solve the above problems, and provides an apparatus for providing a metaverse service using hologram capable of providing a metaverse service (e.g., video conferencing service) without using a wearable device and a method for controlling the same.

The problems to be solved by the present disclosure are not limited to the problems mentioned above, and other problems not mentioned will be clearly understood by those skilled in the art from the description below.

In a general aspect according to one or more examples of the present disclosure to achieve the above task, an apparatus for providing a metaverse service using hologram includes a housing; a plurality of displays installed on each side of the housing at a predetermined angle with respect to a vertical direction and displaying an image; a hologram plate disposed on an upper side of the housing in a horizontal direction and projecting an image displayed on each display as a holographic image in air above each of the displays; a non-contact sensor disposed on top of at least one of the plurality of displays to detect a user's non-contact input; and a controller for processing the user's non-contact input detected through the non-contact sensor.

The apparatus may further include a communication unit for connecting communication with at least one external device and receiving an image from the at least one external device. The controller may display an image received from the at least one external device through the communication unit on the plurality of displays such that the image is projected as a holographic image in air above each of the displays.

The non-contact sensor may transmit Infrared Ray (IR) on a designated area, receive IR reflected by an object on the designated area, and detect the user's input based on the received IR.

The non-contact sensor may be disposed on top of a main display among the plurality of displays. The controller may perform an operation according to the user's input recognized through the non-contact sensor disposed on top of the main display and display an image according to a result of the performance on the plurality of displays.

The apparatus may further include at least one non-contact sensor disposed on top of respective displays except for the main display; and at least one sub-controller for respectively processing non-contact inputs detected through the at least one non-contact sensor.

The housing may include an outer housing forming an appearance of the apparatus; an inner housing of which a hole through which a part of each display is exposed is formed at each side; a plurality of display support units respectively located between sides of the outer housing and sides of the inner housing to support each display; and a lower support unit located between a bottom of the outer housing and a back of the inner housing.

In another general aspect according to one or more examples of the present disclosure, a method for controlling an apparatus for providing a metaverse service using hologram includes displaying images on a plurality of displays; projecting an image displayed on each display as a holographic image in air above each of the displays through a hologram plate; and detecting and processing a user's non-contact input through a non-contact sensor disposed on top of at least one of the plurality of displays.

The displaying of images on the plurality of displays may include displaying at least one image received from at least one external device connected through a communication unit on the plurality of displays.

The detecting and processing of the user's non-contact input may include transmitting IR on a designated area; receiving IR reflected by an object on the designated area; and detecting and processing the user's non-contact input based on the received IR.

The detecting and processing of the user's non-contact input may include detecting and processing the user's non-contact input through a non-contact sensor disposed on a main display among the plurality of displays.

The detecting and processing of the user's non-contact input may include detecting respectively non-contact inputs of a plurality of users through non-contact sensors respectively disposed on top of the plurality of displays; and independently processing the detected respective non-contact inputs.

The present disclosure may provide a more realistic service by providing a metaverse service using hologram. In addition, the present disclosure may solve users' inconveniences by not having to wear additional devices. Further, the present disclosure may solve a view angle issue of the holographic image as the holographic image is provided in multiple (e.g., four) directions. The present disclosure may provide a realistic metaverse service using hologram projected in the air without wearing any additional device (e.g., HMD, VR, AR, etc.) in various environments, such as a game environment where many people compete, a work environment requiring collaboration with many people, an educational environment for teaching many people, a museum, and a zoological park and botanical garden.

### BRIEF DESCRIPTION OF THE DRAWINGS

FIG. 1 illustrates a diagram of an apparatus for providing a metaverse service using hologram according to one or more examples of the present disclosure.

FIG. 2 illustrates an exploded view of an apparatus for providing a metaverse service using hologram according to one or more examples of the present disclosure.

FIG. 3 illustrates a block diagram of an apparatus for providing a metaverse service using hologram according to one or more examples of the present disclosure.

FIG. 4 illustrates a diagram of an example of providing a metaverse service according to one or more examples of the present disclosure.

FIG. 5A illustrates a diagram of the configuration of a device for equally controlling a plurality of holographic images according to one or more examples of the present disclosure.

FIG. 5B illustrates a diagram of the configuration of a device for independently controlling a plurality of holographic images according to one or more examples of the present disclosure.

FIG. 6 illustrates a flow chart of a method for controlling an apparatus for providing a metaverse service using hologram according to one or more examples of the present disclosure.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms (including technical and scientific terms) used in this specification may be used in a meaning that can be commonly understood by those of ordinary skill in the art to which the present disclosure belongs. In addition, terms defined in commonly used dictionaries are not interpreted ideally or excessively unless specifically defined explicitly.

Hereinafter, the present disclosure will be described in more detail with reference to the accompanying drawings.

Before going into detail, the present disclosure relates to an apparatus for providing a metaverse service using hologram and a method for controlling the same without any additional device worn on a user's body. For example, the apparatus may provide a metaverse service by projecting a hologram in the air above the apparatus. In particular, the apparatus may provide a metaverse service by projecting holograms in multiple directions. Hereinafter, for convenience of explanation, the present disclosure will be described in detail by taking a case in which holographic images are projected in four directions as an example.

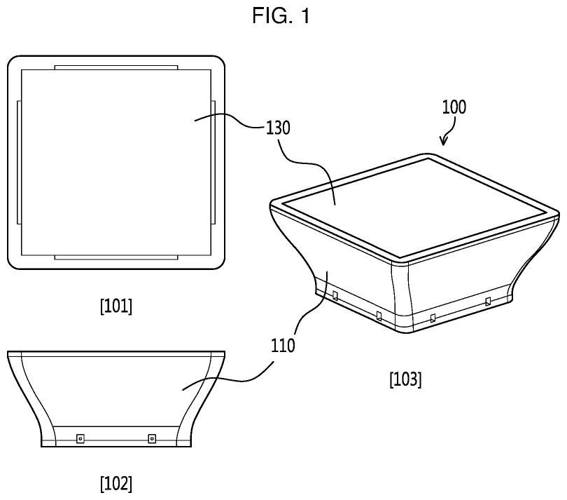

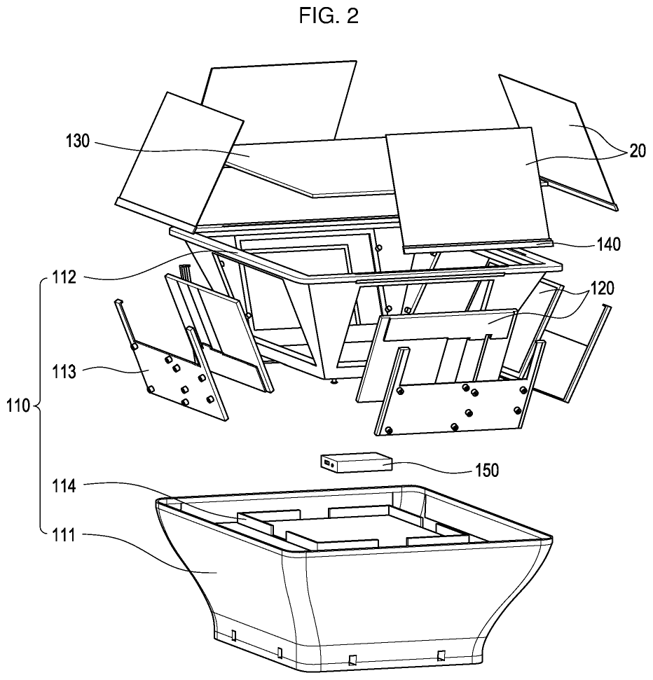

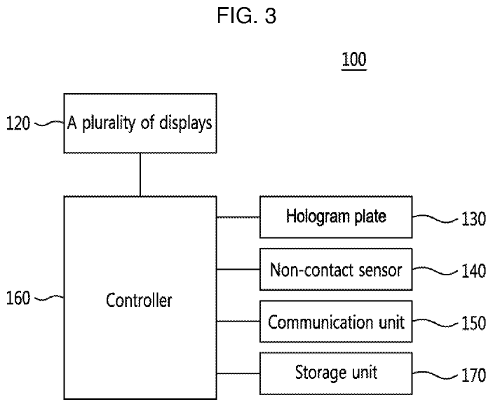

FIG. 1 illustrates a diagram of an apparatus for providing a metaverse service using hologram according to one or more examples of the present disclosure. FIG. 2 illustrates an exploded view of an apparatus for providing a metaverse service using hologram according to one or more examples of the present disclosure. FIG. 3 illustrates a block diagram of an apparatus for providing a metaverse service using hologram according to one or more examples of the present disclosure.

Referring to FIGS. 1 to 3, an apparatus 100 for providing a metaverse service using hologram according to one or more examples of the present disclosure may include a housing 110, a plurality of displays 120, a hologram plate 130, a non-contact sensor 140, a communication unit 150, a controller 160, and a storage unit 170.

The housing 110 has a shape similar to a rectangular parallelepiped, and components such as a display unit 120, a hologram plate 130, a non-contact sensor 140, a communication unit 150, and a controller (not shown) may be disposed therein. For example, the housing 110 of the apparatus 100 has a rectangular top and bottom, and the area of the top may be larger than the area of the bottom, as illustrated in drawings of numerical symbols 101, 102, and 103 of FIG. 1.

The housing 110 may include: an outer housing 111 forming an appearance; an inner housing 112 disposed inside the outer housing 111 and having holes through which the displays 120 are partially exposed on each side thereof; a plurality of display support units 113 respectively located between sides of the outer housing 111 and sides of the inner housing 112 to support the displays 120; and a lower support unit 114 located between the bottom of the outer housing 111 and the back of the inner housing 112.

The hologram plate 130 may be disposed on an upper side of the housing 110. The interior of the housing 110 may remain in darkroom condition.

The plurality of displays 120 are installed on each side of the housing 110 at a predetermined angle with respect to a vertical direction (e.g., 30 degrees or more to less than 90 degrees) and may display images.

The hologram plate 130 is disposed in the horizontal direction on the upper side of the housing 110 and may project an image displayed on respective displays 120 as a holographic image 20 in the air above respective displays. Herein, a hologram is a technology for recording and reproducing three-dimensional information by using an interference phenomenon caused by two lights meeting each other. The holographic image 20 appears to float in the air and may generate an effect that a user sees a three-dimensional stereoscopic image.

In the hologram plate 130, a first hologram plate and a second hologram plate arranged to have a predetermined angle (e.g., 90°, 80°, 70°, etc.) with each other may be regularly arranged. For example, the first hologram plates are arranged at a predetermined intervals in the horizontal direction; the second hologram plates are arranged at predetermined intervals in the vertical direction; and the second hologram plates may be disposed on the first hologram plates. Light emitted from the display 120 is reflected from the first hologram plate, reflected from the second hologram plate positioned at a predetermined angle with the first hologram plate, and projected as a holographic image in the air.

The non-contact sensor 140 may be disposed on top of at least one of the plurality of displays 120 to detect a user's non-contact input. For example, the non-contact sensor 140 transmits IR on the designated area (e.g., an area where the holographic image 20 is displayed), receives IR reflected by an object (e.g., the user's hand) in the designated area, and detects the user's non-contact input based on the received IR.

According to one example, the non-contact sensor 140 may be disposed on top of a main display among the plurality of displays 120. According to another example, the apparatus 100 may further include at least another non-contact sensor disposed on top of the other displays except for the main display. In other words, the apparatus 100 may include only one non-contact sensor on the main display or may include non-contact sensors on top of each of the plurality of displays 120.

The communication unit 150 may connect communication with at least one external device and receive an image from the at least one external device. The received image may be displayed on the plurality of displays 120 and projected as a holographic image in the air above each display by the hologram plate 130.

The controller 160 may control the overall operation of the apparatus 100. For example, the controller 160 may control an image to be displayed on the displays 120. In addition, the controller 160 may process a user's input detected through the non-contact sensor 140. According to one example, the controller 160 may control the overall operation of the apparatus and may include a main controller that processes the user's input detected through the non-contact sensor located on the main display; and at least one sub-controller that processes the user's input detected through the non-contact sensor located on top of at least one other display.

The storage unit 170 may store various data and information. The storage unit 170 may store images displayed on the display 120 and/or programs for executing various commands for controlling the apparatus 100.

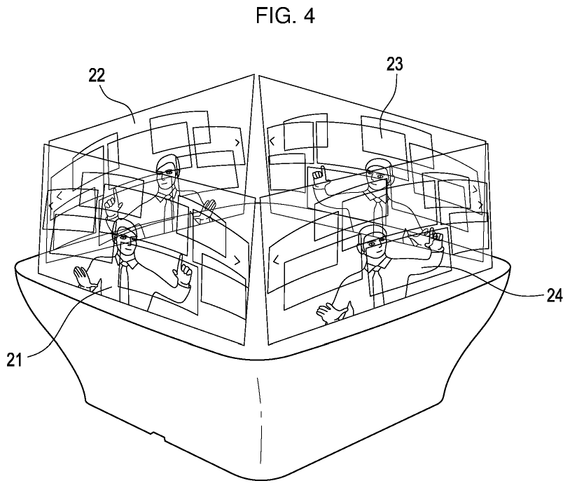

FIG. 4 illustrates a diagram of an example of providing a metaverse service according to one or more examples of the present disclosure.

Referring to FIG. 4, a metaverse service is provided by projecting four holographic images on top of an apparatus 100 to different locations according to one example of the present disclosure. For example, the apparatus 100 may project first to fourth holographic images 21, 22, 23, 24. Through the metaverse service using hologram, it may be capable of holding a video conference with people in a remote place, sharing contents (e.g., videos, photos, etc.), or playing game.

Meanwhile, current holographic images have a limited viewing angle due to technical limitations; however, the apparatus 100 according to the present disclosure projects a plurality of holographic images in various positions (e.g., in four directions) and thus a user may be able to view holographic images in multiple directions, thereby solving the problem of the viewing angle of the holographic image. For example, a plurality of users sit around the apparatus 100 and perform video conferences, games, video viewing, etc. using holographic images.

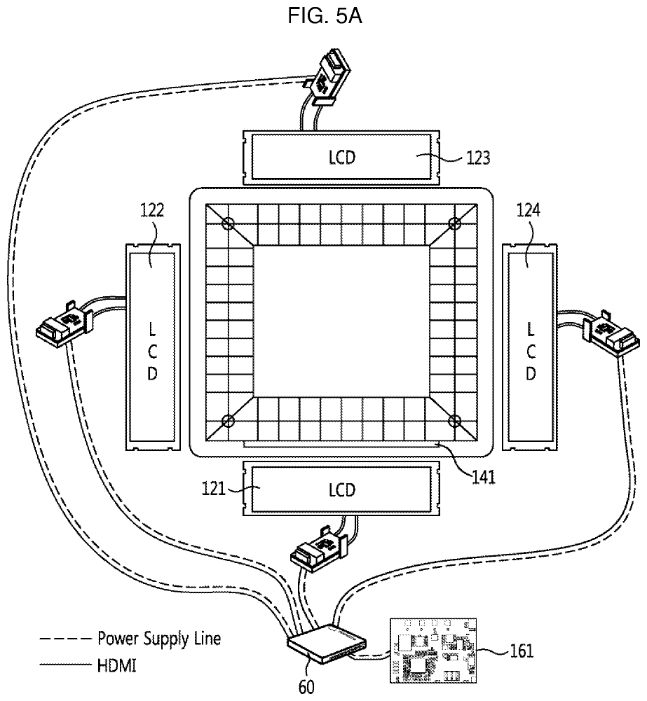

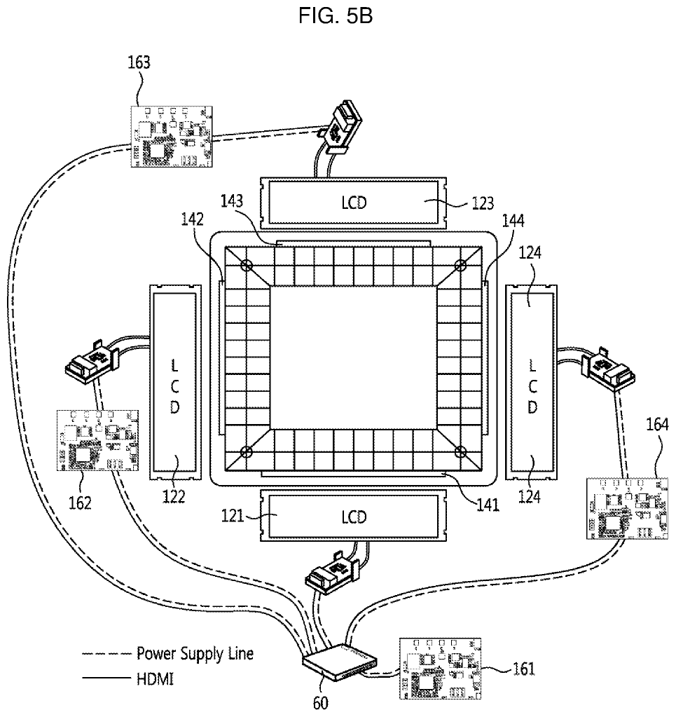

FIG. 5A illustrates a diagram of the configuration of a device for equally controlling a plurality of holographic images according to one or more examples of the present disclosure.

Referring to FIG. 5A, a device according to one example of the present disclosure may include one non-contact sensor 141 and one controller (hereinafter referred to as main controller 161). The main controller 161 distributes an image displayed on a main display 121 to other displays 122, 123, 124 through a distributor 60 so that the plurality of displays 121, 122, 123, 124 display the same image. Due to this, the same holographic image may be projected on top of each display. In addition, since only one non-contact sensor 141 is included on top of the main display 121, the device may be controlled only by a main user (e.g., a user located around the main display 121). This type of device may be used for one-way information transfer, such as education, seminars, etc.

FIG. 5B illustrates a diagram of the configuration of a device for independently controlling a plurality of holographic images according to one or more examples of the present disclosure.

Referring to FIG. 5B, a device according to one example of the present disclosure may include a plurality of non-contact sensors 141, 142, 143, 144 and a plurality of controllers 161, 162, 163, 164. Here, the plurality of controllers may be divided into a main controller 161 and a plurality of sub-controllers 162, 163, 164. The plurality of non-contact sensors 141, 142, 143, 144 may be respectively positioned on top of a plurality of displays 121, 122, 123, 124. The main controller 161 processes a user input detected through a first non-contact sensor 141, and the sub-controllers 162, 163, 164 process a user input detected through second to fourth non-contact sensors 142, 143, 144, respectively. Due to this, the device may independently control holographic images projected on top of each display. This type of device is useful for providing services in which a plurality of users collaborate (e.g., video conference).

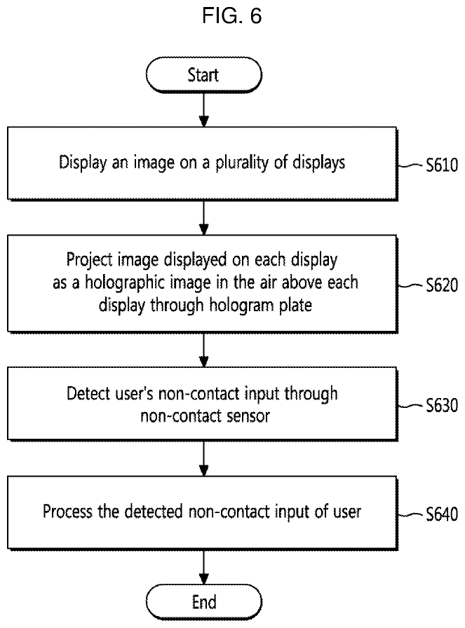

FIG. 6 illustrates a flow chart of a method for controlling an apparatus for providing a metaverse service using hologram according to one or more examples of the present disclosure.

Referring to FIG. 6, a method for controlling an apparatus for providing a metaverse service using hologram according to one or more examples of the present disclosure includes: displaying an image on a plurality of displays (S610), projecting the image displayed on each display as a holographic image in the air above each display through a hologram plate (S620), detecting a user's non-contact input through a non-contact sensor (S630), and processing the detected non-contact input (S640).

In the displaying of the image, the apparatus may receive an image from at least one external device connected through a communication unit and display the received at least one image on the plurality of displays. For example, when connecting to one external device or receiving an image from one of a plurality of external devices, the apparatus may display one image on each display. Meanwhile, when receiving images from a plurality of external devices, the apparatus may merge the received images into one image and display the merged image on each display.

In the detecting of user's non-contact input, through IR projected parallel to and coincident with a designated area (e.g., an area where a holographic image is displays), the apparatus may receive IR reflected by a user's hand motion on the designated area through a non-contact sensor and detect the user input according to the user's hand motion based on the received IR. For this, the non-contact sensor may include: a light emitting module for irradiating IR to the designated area; a light receiving module for receiving IR reflected by a user's hand; and an arithmetic module for detecting the user's non-contact input based on the reflected IR received through the light receiving module.

Meanwhile, the non-contact sensor may be disposed on top of at least one of a plurality of displays. For example, the non-contact sensor may be disposed on top of a main display only among the plurality of displays. Alternatively, the non-contact sensor may be respectively disposed on top of the plurality of displays. In this case, the apparatus may respectively detect non-contact inputs of a plurality of users through respective non-contact sensors and independently process the detected non-contact inputs.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Therefore, the scope of the disclosure is defined not by the detailed description, but by the claims and their equivalents, and all variations within the scope of the claims and their equivalents are to be construed as being included in the disclosure.

1. An apparatus for providing a metaverse service using hologram, comprising:
a housing;
a plurality of displays installed on each side of the housing at a predetermined angle with respect to a vertical direction and displaying an image;
hologram plates disposed on an upper side of the housing in a horizontal direction and projecting an image displayed on each of the displays as a holographic image in air above each of the displays, wherein
the hologram plates include first hologram plates and second hologram plates arranged at a predetermined angle to each other,
the first hologram plates are spaced apart in the horizontal direction at predetermined intervals, and
the second hologram plates are spaced apart in the vertical direction at predetermined intervals and disposed on the first hologram plates;
a non-contact sensor disposed on top of at least one of the displays to detect a user's non-contact input; and
a controller for processing the user's non-contact input detected through the non-contact sensor.

2. The apparatus of claim 1,
wherein the displays include at least four displays respectively disposed in at least four directions.

3. The apparatus of claim 1, further comprising:
a communication unit for connecting communication with at least one external device and receiving an image from the at least one external device,
wherein the controller displays the image received from the at least one external device through the communication unit on the displays such that the image is projected as a holographic image in air above each of the displays.

4. The apparatus of claim 1,
wherein the non-contact sensor transmits Infrared Ray (IR) on a designated area, receives IR reflected by an object on the designated area, and detects the user's non-contact input based on the received IR.

5. The apparatus of claim 1,
wherein the non-contact sensor is disposed on top of a main display among the displays, and
wherein the controller performs an operation according to the user's non-contact input recognized through the non-contact sensor disposed on top of the main display and displays an image according to a result of the performance on the displays.

6. The apparatus of claim 5, further comprising:
at least one non-contact sensor different from the non-contact sensor and disposed on top of at least one of the displays except the main display; and
at least one sub-controller for respectively processing non-contact inputs detected through the at least one non-contact sensor.

7. The apparatus of claim 1,
wherein the housing comprises:
an outer housing forming an appearance of the apparatus;
an inner housing of which a hole through which a part of each of the displays is exposed is formed at each side;
a plurality of display support units respectively located between sides of the outer housing and sides of the inner housing to support each of the displays; and
a lower support unit located between a bottom of the outer housing and a back of the inner housing.

8. A method for controlling an apparatus for providing a metaverse service using hologram, comprising:
displaying images on a plurality of displays;
projecting an image displayed on each of the displays as a holographic image in air above each of the displays through hologram plates; and
detecting and processing a user's non-contact input through a non-contact sensor disposed on top of at least one of the displays, wherein
the hologram plates include first hologram plates and second hologram plates arranged at a predetermined angle to each other,
the first hologram plates are spaced apart in a horizontal direction at predetermined intervals, and
the second hologram plates are spaced apart in a vertical direction at predetermined intervals and disposed on the first hologram plates.

9. The method of claim 8,
wherein the displaying of images on the displays comprises displaying at least one image received from at least one external device connected through a communication unit on the displays.

10. The method of claim 8,
wherein the detecting and processing of the user's non-contact input comprises:
transmitting IR on a designated area;
receiving IR reflected by an object on the designated area; and
detecting and processing the user's non-contact input based on the received IR.

11. The method of claim 8,
wherein the detecting and processing of the user's non-contact input comprises detecting and processing the user's non-contact input through a non-contact sensor disposed on a main display among the displays.

12. The method of claim 8,
wherein the detecting and processing of the user's non-contact input comprises:
detecting respectively non-contact inputs of a plurality of users through non-contact sensors respectively disposed on top of the displays; and
independently processing the detected respective non-contact inputs.
